(19) United States
(12) Patent Application Publication
(10) Pub. No.: US 2002/0144256 A1
(43) Pub. Date: Oct. 3, 2002

(54) Method of deployment for concurrent execution of multiple versions of an integration model on an integration server

(76) Inventors: Navin Budhiraja, Fremont, CA (US); Gregory Mueller Cole, (US)

Correspondence Address: NIXON PEABODY, LLP, 8180 GREENSBORO DRIVE, SUITE 800, MCLEAN, VA, 22102, US

(21) Appl. No.: 09/984,978

(22) Filed: Oct. 31, 2001

Related U.S. Application Data
(63) Continuation-in-part of application No. 09/823,953, filed on Mar. 30, 2001.

(51) Int. Cl. G06F 9/445

(52) U.S. Cl. 717/174

(57) ABSTRACT

A method of executing plural versions of business process management software on a single integration server. A plurality of components are defined. The components can include executable process logic of a business process and at least one port defining a standard representation of an external interface of said component. Connections between ports of desired components are also defined. The components and connections are stored in a repository as a set objects and the set of objects is loadedas a first version in a first runtime environment by configuring run time properties of the set of the objects. After modification of the set of objects, the modified set can be loaded as a second version in a second runtime environment by configuring run time properties of the set of the objects as modified.

### RELATED APPLICATION DATA

This application is a continuation-in-part of U.S. application Ser. No. 09/823,953 filed on Mar. 30, 2001 and entitled Versioning Method for Business Process Models, the disclosure of which is incorporated herein by reference. This application is also related to Applicant's application entitled Integrated Business Process Modeling Environment and Models Created Thereby concurrently filed herewith, the disclosure of which is also incorporated herein by reference.

### BACKGROUND

The present invention relates generally to methods for executing programs, such as those represented by business process models. More particularly, the present invention relates to a method that facilitates concurrent execution of multiple versions of a business process.

An integration server, or business process management system, is a computer system that executes automated and/or manual business processes. Business processes are steps that a business undertakes to accomplish some objective, such as hiring an employee, processing an order, or procuring components required for production. As an example, consider the case of a retail business. For this type of environment, a business process might track customer orders. Business process management systems are typically designed in a way that makes their behavior easy to customize. This allows the same underlying system to be deployed in a range of different environments and with different software applications.

To provide this type of flexibility, some integration servers have adopted a model-driven approach which describes business processes in terms of business process models. A business process model can be thought of as a formal definition of a business process and can be expressed in a high-level graphical modeling language such as UML (Uniform Modeling Language). Business process models define the runtime behavior of business process instances using state diagrams. The states appear as graphical objects and the connections between states are known as transitions. An instance of the executing business process will traverse transitions and move between states in response to events. Events are notification within the model that something has happened in the real world. Customers placing orders and customers canceling orders are two examples of events. The model-driven approach can be powerful because it facilitates creation and manipulation of business processes within a graphical environment. This allows designers to create business process models in a manner similar to operating a typical drawing program, without concern for the underlying computer code. In this way, model-driven business process management systems greatly reduce the need for highly skilled programmers. Recently, the model-driven approach has been extended to the integration of various applications. For example, the BusinessWare™ modeling environment sold by Vitria™ Technology, Inc. permits modeling of the integration of applications in a graphical manner.

The concept of “value chains,” i.e., a series of business activities that create value, has become a useful paradigm for analyzing and improving the efficiency of businesses. Such activities include business processes, such as order entry, shipping, invoicing, CRM, and the like. Value chains are dependent on the internal business processes of a company, the business processes of trading partners, such as suppliers, and the relationship between the company and trading partners. It has become popular to experiment with and change value chains to optimize profitability. Such change requires modification of business processes and deployment of a modified version of a business process model.

Unfortunately, in operational business process management systems, it may be undesirable or impossible to halt the system to update a business process. Even in cases where this is possible, shutdown may still be difficult if the system is populated with instances created using the old version of a business process. For example, the system may contain pending orders, represented by instances, at the time of shutdown for change to a new version. As a result, shutdown often requires that the system be maintained in a partially operational configuration (e.g., running but not accepting new orders) until all instances of pending orders have been fully processed.

In the case where some of the business processes correspond to applications of a trading partner or other external party, changes to business processes can be even more difficult to effect because such changes often require changes to the applications of the external party. As a result, an extended period of time may be required to propagate changes to all applications and all organizations. Halting the system down to facilitate the updating of a business process is not always practical or possible. It is known to run multiple versions of business processes on multiple integration servers, i.e. each version on a different integration server. However, running versions on different servers creates undesirable complexities and discontinuities.

As a result, there is a need for methods that simplify the deployment of new versions of business process models. This need is particularly important in environments where system shutdown is difficult or otherwise undesirable.

### SUMMARY OF THE INVENTION

An object of the invention is to facilitate running of multiple versions of business process integration software on a single integration server. To achieve this an other objects, a first aspect of the invention is a method of deploying multiple versions of computer code for executing one or more business processes in an integration server. The method comprises defining a plurality of objects, at least some of the objects including executable process logic of a business process and at least some of the objects comprising connection information between business processes, storing the objects as a project corresponding to an integration model in a repository, deploying a first version of the software in a first runtime environment of the integration server, modifying the project, and deploying the modified project as a second version of the software in a second runtime environment of the same integration server.

A second aspect of the invention is a method of deploying plural versions of an object oriented, graphical model of a computer architecture for integrating business processes. The method comprises defining a plurality of components, at least one of the components including executable process logic of a business process and at least one port defining a standard representation of an external interface of said component, defining connections between ports of desired components, storing the components and connections in a repository as a project, deploying the project as a first version in a first runtime environment by configuring run time properties of the project, modifying the project, and deploying the project, as modified, as a second version in a second runtime environment by configuring run time properties of the modified project.

### BRIEF DESCRIPTION OF THE DRAWING

The invention will be described through a preferred embodiment and the accompanying drawing, in which:

FIG. 1 is a block diagram of a computer architecture for use with the preferred embodiment;

FIG. 2 is an example of an integration model created by the graphical modeling module of the architecture of FIG. 1;

FIG. 3 illustrates a business process model of the example of FIG. 2;

FIG. 4 illustrates the configuration display screen of the preferred embodiment;

FIG. 5 illustrates the partitioning display of the preferred embodiment;

FIG. 6 is a flowchart of a deployment method of the preferred embodiment; and;

FIG. 7 is a flowchart illustrating the deployment steps of FIG. 6 in detail.

### GLOSSARY

The following description below uses terms of art which are defined below:

Business Process Model—A state machine that models business processes at a semantic level and defines an executable specification for the underlying business logic.

Channel—A connector component which models an asynchronous communication using the publish/subscribe paradigm.

Class—a modular object oriented unit of code.

Component—A reusable graphical representation of a business process model or other system element. A component can represent a business process model, a transformation, a process query, or another integration model and interacts with other components through a defined interface.

Deployment—The physical arrangement and configuration of a model.

Instance—A particular execution of a business process model or integration model.

Integration Model—A model that describes interactions between business processes from a data flow perspective.

Java Virtual Machine (JVM)—An abstract computing machine, or virtual machine, that provides a platform-independent programming language that converts Java bytecode into machine language and executes it.

Lightweight Directory Access Protocol (LDAP)—A set of protocols for accessing information directories.

Model—A representation in a certain form that captures the important aspects of the thing being modeled from a certain point of view and simplifies the rest.

Object—Generally, any item, or a graphical representation of the item, that can be individually selected and manipulated.

Port—A representation of the set of interfaces a component exposes.

Project—A set of objects that can be deployed as a runtime application.

### DETAILED DESCRIPTION

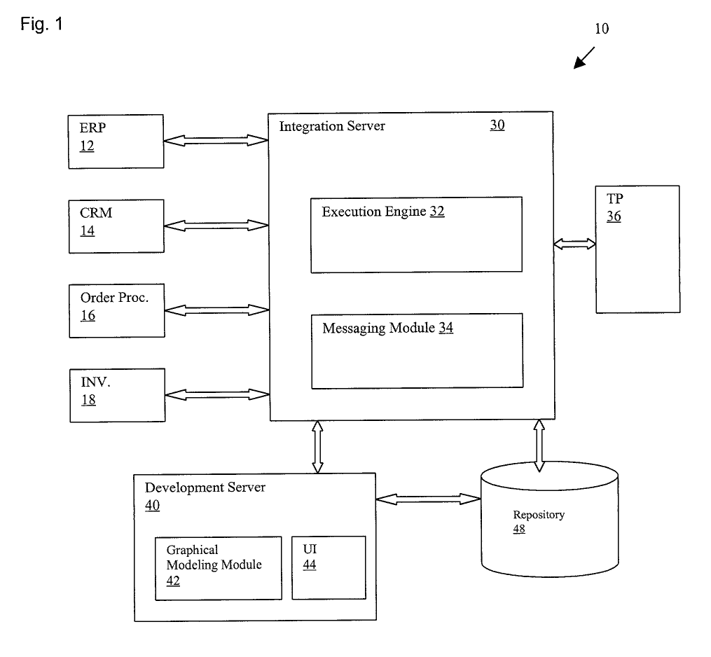

FIG. 1 illustrates computer architecture 10 for developing, deploying, and executing integration models in accordance with a preferred embodiment. Business process systems, such as ERP system 12, CRM system 14, order processing system 16, and inventory system 18 control associated business processes and are coupled to integration server 30 over a network or other communication channel. In addition, trading partner system 36, such as the integration server of a supplier or other external party, is coupled to integration server 30 over the Internet or other communication channel. Integration server 30 is coupled to development server 40 and repository 48 through appropriate communication channels such as a local area network. Repository 48 is illustrated as a separate device but can be embodied within integration server 30 or development server 40. Repository 48 includes a storage device and can include processing logic as will become apparent below.

Development server 40 includes graphical modeling module 42, in the form of software, which provides the process modeling environment, including a user interface, for configuring business process models and integration models. Integration server 30 includes execution engine 32 for executing an integration model after deployment. Integration models are executed by execution engine 32 by directing the flow of information among the underlying internal and external systems 12, 14, 16, 18, and 36. After defining the business processes that need to be automated, a developer then creates visual models of those processes, and the integration thereof, using a graphical interface. The resulting integration model consists of plural components representing underlying executable code for executing and integrating the various business processes.

Integration server 30 also includes messaging module 34 which serves as a messaging layer or infrastructure for execution engine 32 and systems 12, 14, 16, 18, and 36. For example, an event-driven publish-subscribe methodology can be deployed via communications channels to transport information in a consistent format between systems. In the case of communication with external systems, messaging module 34 can transform data into standard formats, such as XML, EDI, or any other known or future protocols, and transport the data in an encrypted form over networks using standard protocols such as HTTP, FTP and SMTP.

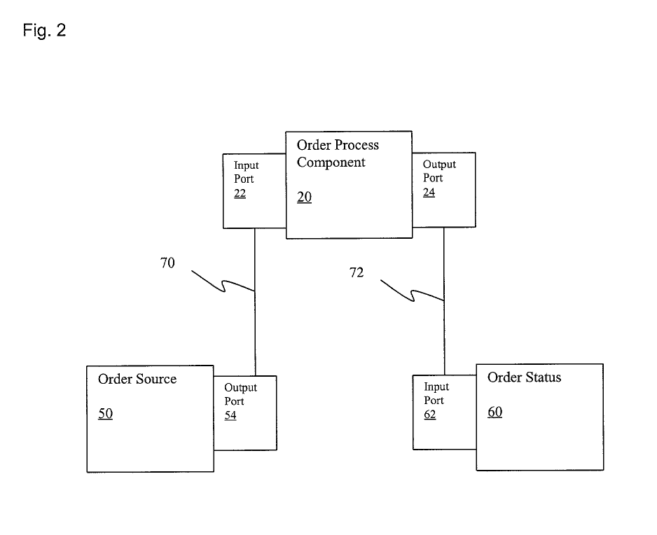

FIG. 2 illustrates a simple example of an integration model developed by modeling module 42. The integration model consists of order process component 20 representing an underlying business process model as discussed in detail below, order source component 50, and order status component 60. Order source component 50 can represent an external system of a trading partner or any other source of order information. Order status component 60 can represent a database file or any other system for recording and/or tracking order status. Order source component 50 and order status component 60 can include transformations that serve to transform one data format to another to exchange information between the systems represented by the components. Order process component 20 has input port 22 and output port 24 associated therewith, order source component 50 has output port 54 associated therewith, and order status component 60 has input port 62 associated therewith. The appropriate ports are connected by lines, referred to as “wires” herein, which define the connections between ports. Specifically wires 70 and 72 couple the ports as illustrated. Ports are described in greater detail below. All elements can be created, configured, and manipulated through the user interface of modeling module 42 in a graphical manner, much the same as in a simple drawing program.

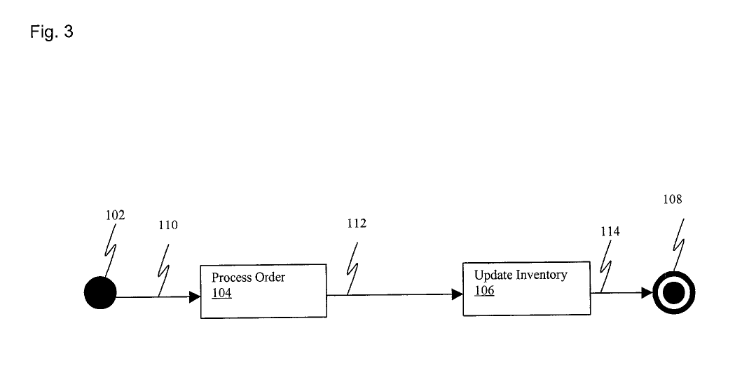

The business process model underlying order process component 20 can also be created in a graphical environment using modeling module 42. FIG. 3 illustrates an example of such a business process model. The business process model consists of four states, start state 102, process order state 104, update inventory state 106, and termination state 108. Transitions 110, 112, and 114 connect the states as illustrated. Transitions define the logic that is executed to move an instance of the business process model from one state to the next state. Accordingly, transitions may have action code associated therewith. The action code can be any code that can be executed directly, compiled, translated, or otherwise processed for execution. For example, the action code can be a Java object. An example of such action code, which records order information to be processed, is below:

//record the order

myOrder.order(order)

CommonMessages.logGenericTrace (“Order”+myOrder.oid( )+“received from customer”+order.customer);

Returning to the integration model of FIG. 2, ports define a standard way to represent the external interface of components. Ports are used to communicate dataflow between components. The upstream port component is defined as an output port and the downstream port component is defined as an input port. Each port has underlying properties that can be assigned during integration model development and/or deployment. A property sheet can be accessed through the user interface of modeling module 42 by right clicking on the port component, selecting a command from a menu, or the like. The properties associated with all components, and ports can be stored as objects in a directory structure in repository 48, which is an LDAP directory in the preferred embodiment, as described below, for access by the runtime environment. Repository 48 acts as a shared directory service that can be accessed remotely. When a component is created, code is automatically generated in correspondence to the component for looking up connection information for each port of the component, including the port to which it is connected, the type of the port and how to connect to the port. At runtime, this code serves to identify and bind the proper communication protocols.

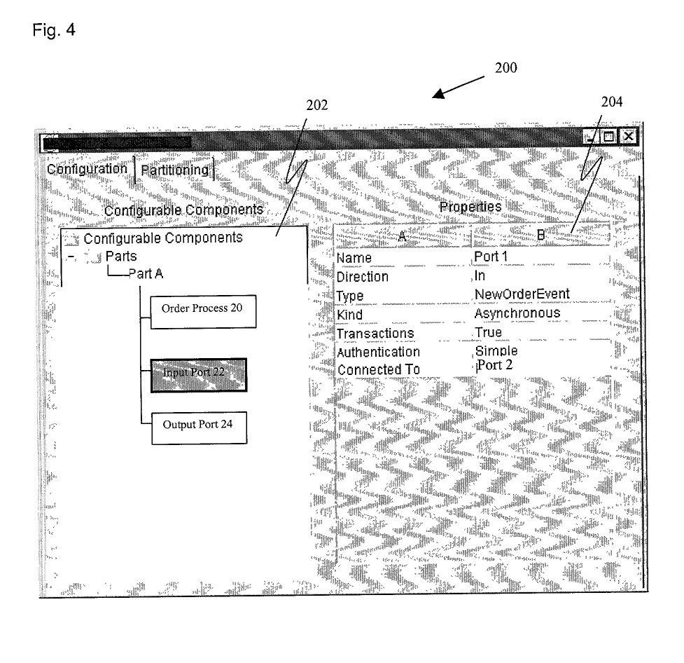

FIG. 4 illustrates the configuration display of screen 200 for viewing the objects stored in repository 48. In the preferred embodiment, the objects are displayed in a directory tree structure in window 202. It can be seen that the objects are grouped in a logical manner. For example, the folder named “Part A” includes the objects for order process component 20, the associated input port 22, and the associated output port 24. Of course, all other objects corresponding to an integration model, and objects corresponding to other integration models can be stored in repository 48 and displayed in window 202. However, in FIG. 4, such other objects have been omitted for clarity. Display window 204 displays a property sheet corresponding to the currently selected object in window 202. In this example, input port 22 is selected and indicated by the user interface by shading. It can be seen that the property sheet includes the port name, the port direction, the port type, the kind of port, the transactions of the port, the type of authentication, and the connections of the port. These properties can be either selected by the model designer or automatically assigned by the model configuration as described below.

The port name can be an arbitrary name assigned to the port to distinguish the port and its object from other ports and components. The name can be selected by the designer or automatically assigned by modeling module 42. For example, the ports can be numbered in order of their creation or position in the model. Also, the ports can named based on the name of the component to which they are associated. For example, port 22 could be named “Order Process Input Port.” The direction indicates the direction of flow of data or events through the port. The direction can be assigned automatically by automation module 42 based on the type of port and/or the connections which are defined by the wires described above. For example, input port 22 has a direction of “in” because, by definition, it is an input port.

The port type indicates the operation or event that passes through the port. For example, port 22 receives and event called “NewOrderEvent.” This event is defined by the event passing through output port 54 connected to input port 22 by wire 70 (see FIG. 2). The event “NewOrderEvent” is an output event of the business process model underlying order source component 50. In this example, port 22 operates in a synchronous mode and is coupled directly to port 54 by wire 70. If communication between ports is to be asynchronous, meaning that the ports subscribe to a channel, que or the like and need not be ready to receive an event when the event is created, the appropriate component, such as a channel component, will be inserted in the model between the ports. The transactions of the port is “True” meaning that transactions can be propagated across components by invocation. The authentication of the port is “Simple” meaning that only password security is applied. In the alternative, authentication can be complex and require a certificate, key, or the like. Also, the port is connected to Port 2, which is the port name assigned to output port 54 in this example. This connection is automatically set based on the wires configured in the integration model illustrated in FIG. 2.

Once the integration model is configured, it represents a logical description of an application. Of course, to be executed, the model must be turned into a physical description that can be run in a run time environment. The process of changing from a logical model to a specific physical model is referred to as “deployment” herein. Deployment in the preferred embodiment consists of deployment configuration, partitioning, packaging, and installation steps. Once the integration model is created using modeling module 42, the integration model can be deployed for a test environment or a production environment.

Deployment configuration refers to the steps involved in filling out unresolved component references including, component-specific properties, security references, and environment properties. Partitioning deals with making the application run efficiently by placing components on different machines on a distributed environment. Partitioning must take into account the network topology, as well as characteristics of the nodes on which components are partitioned. Specifically, partitioning refers to placing the component in a ‘home’ node and server (channel server, web server or integration server) where it is to execute. The node and server provide a deployable destination with a ready environment. Integration model components may be partitioned onto integration server 30. Channels may be partitioned onto a channel server. Partitioning allows for distribution of components across multiple devices, i.e. nodes. Accordingly, the phrase “integration server” can refer to one node or a set of plural nodes. When multiple versions are said to execute on the “same integration server,” the versions run on the same node or the same set of nodes that defines the integration server. Packaging refers to how the components are organized into a unit fit for distribution/execution. For example, the Java standard for packaging components is a jar (Java application resource) file, which can be used with the preferred embodiment.

Installation refers to how the files representing the solution are actually moved to the target nodes. The deployment package can be a shared directory service in repository 48. Runtime components and tools can all reference this location. Alternatively, the deployment package can be stored separately and extracted into repository 48 at a later time. Startup refers to how the configured, installed application is actually executed in its target environment.

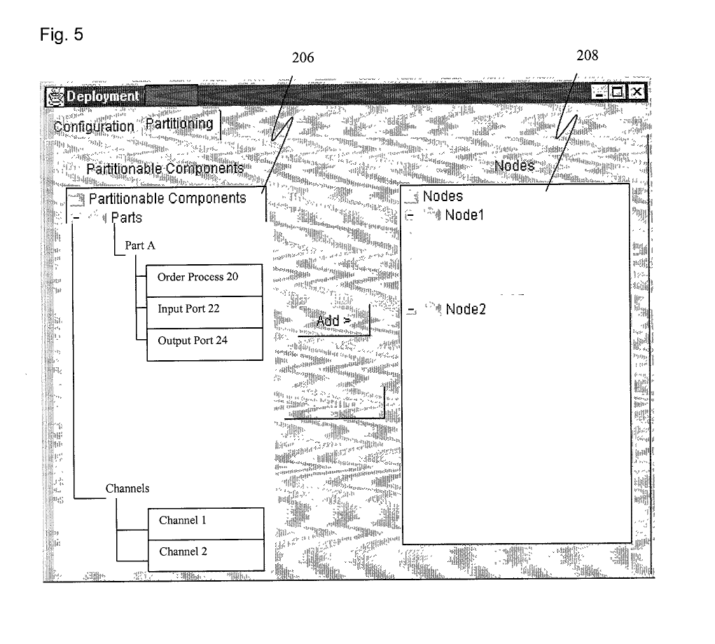

By selecting the partitioning tab of display 200 in FIG. 4, the deployment display of FIG. 5 is called up. The deployment display includes window 206 which shows all deployable objects of an integration model or plural integration models, some of which are omitted in FIG. 5 for simplicity, in a directory tree structure. Also, window 208 shows all physical nodes, i.e. computers, directories, networks, or the like of the physical distributed system, some of which are omitted in FIG. 5 for simplicity, in a directory tree structure. The designer can select an object in window 206 and a node in window 208 and press the “Add” button to partition the selected component to the selected node. Alternatively, a “drag and drop” interface can be used. The selected component object will be placed in the tree structure of window 208 under the selected node. Component objects can be selected from window 208 and the “Remove” button can pressed to un-partition the component.

A button or menu selection can be activated to create a deployment package, e.g. a jar file, deployment descriptors, and any other files needed for deployment. The deployment package can be stored in repository 48. Subsequently, error checks can be accomplished and the deployment can be installed in the proper resources.

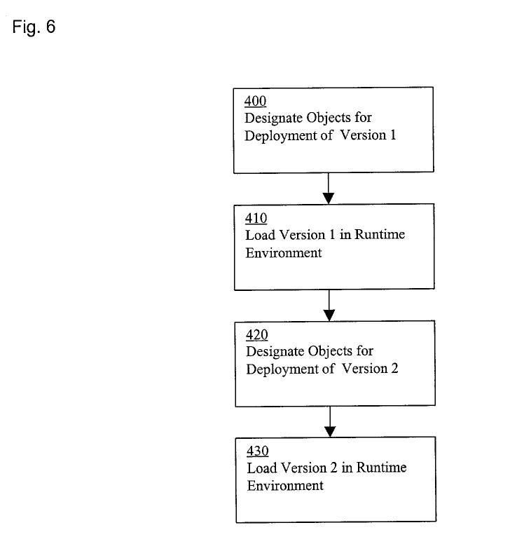

FIG. 6 illustrates the method of deploying plural versions of a project in integration server 30 in accordance with the preferred embodiment. In the preferred embodiment, the executable code corresponding to components is Java code and is stored as a plurality of files each corresponding to a Java class. The designer can select a set of components to define a first version of a project, during deployment described above, which correspond to a first version of the integration model to be deployed in step 400. In step 410, the selected files are deployed into repository 30 and loaded in the manner described above in a first runtime environment. Assuming the integration model version is desired to be changed, to accommodate a change in a business process model or the like, a second version of the project to be deployed can be selected in step 420 and loaded as version 2 in a second runtime environment of integration server 30 in step 430. The set of components defining the first version of the project in 420 is modified with respect to the set of components defining the second version of the project in step 410. The modification can include changes to a component, addition of components, subtraction of components or changes in connections between components.

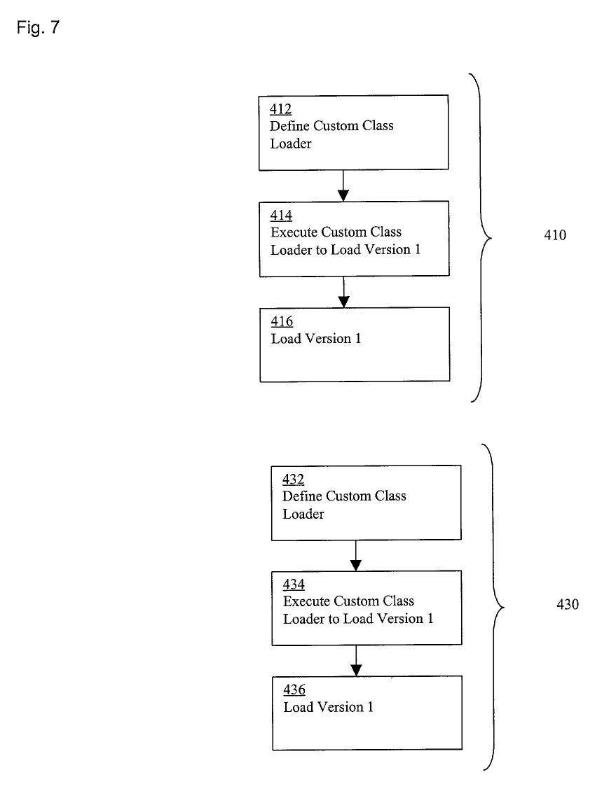

FIG. 7 illustrates the deployment steps 410 and 430 in detail. In step 412, a custom loader is defined for version 1. A loader is a known operating system utility that copies files from a storage device, repository 30 in the preferred embodiment, to main memory where the files can be executed. A loader may also replace virtual addresses with physical addresses for the particular runtime environment. The Java domain includes a class loader that dynamically loads classes by calling the public loadClass( ) method. However, in the preferred embodiment a custom loader is defined. For example, the method URLClassLoader( ) can be used to load only classes having specific URLs, i.e. desired classes. Each URL can represent a file of a component selected in step 400. In step 414, the custom class loader is executed to place the desired Java class files in repository 30 for execution. Properties and other information can be loaded based on version information of the objects. In step 416, the loaded classes and other information are loaded in a Java Visual Machine in integration server 30 and executed.

Similarly, in step 432, a custom class loader is defined for version 2. In step 434, the custom class loader is executed to place the desired Java class files in repository 30 for execution. In step 436, the loaded classes and other information are loaded in a the JVM in integration server 30 and executed. The JVM defines a “machine within a machine” and mimics a real processor, enabling the two versions of Java bytecode to be executed independently of one another regardless of the operating system. Accordingly, various versions of an integration model can be created and simultaneously deployed and executed on the same integration server. The versions can be executed concurrently on the same integration server. Note that different versions can be the result of a change to a specific component or components, addition of new components, or the change in structure of an integration model. Further, dependent versions can be isolated in the manner described above.

It can be seen that the preferred embodiment provides an integrated modeling environment in which the business process logic is separated from back-end integration and system issues. This separation allows the business analyst, not the programmer, to focus on the important work of designing business rules to solve specific business issues. Such separation also enables deployment of various versions of an integration model concurrently on the same integration server.

As described above, the repository serves as a shared directory service and stores all project information. Accordingly, to undeploy a project, the user merely designates the project and the development server can remove all project information from the repository. Accordingly, undeployment can be accomplished efficiently and completely.

The invention can be implemented on any device, such as a personal computer, server, or any other general purpose programmable computer or combination of such devices, such as a network of computers. Communication can be accomplished through any channel, such as a local area network (LAN), the Internet, serial communications ports, and the like. The communications channels can use wireless technology, such as radio frequency or infra-red technology. The various elements of the preferred embodiment are segregated by function for the purpose of clarity. However, the various elements can be combined into one device or segregated in a different manner. For example, software can be a single executable file and data files, or plural files or modules stored on the same device or on different devices. Any protocols, data types, or data structures can be used in accordance with the invention. The invention can be used to design, create, manipulate, test or use any business process model or integration model and can be used in combination with any type of system for affecting business processes. Any appropriate user interface can be used to design, create, and manipulate models. The underlying code can be written in any language, such as Java, or the like.

The invention has been described through a preferred embodiment. However, various modifications can be made without departing from the scope of the invention as defined by the appended claims and legal equivalents thereof.

What is claimed is:

1. A method of deploying multiple versions of computer code for integrating business processes in an integration server, said method comprising:
(a) defining a project comprising a plurality of objects, at least some of said objects including executable process logic of a business process and at least some of the objects comprising connection information between business processes;
(b) storing the objects as a set corresponding to an integration model in a repository to be executed in a runtime environment of the integration server;
(c) loading the set of objects as a first version of the project in a first runtime environment of the integration server;
(d) modifying the set of the objects; and
(e) loading the modified set of objects as a second version of the project in a second runtime environment of the same integration server.

2. A method as recited in claim 1, wherein said step (d) comprises modifying one of the objects in the set of the objects.

3. A method as recited in claim 1, wherein said step (d) comprises adding an object to the set of the objects.

4. A method as recited in claim 1, wherein said step (d) comprises modifying the executable process logic of at least one of the objects.

5. A method as recited in claim 1, wherein said step (d) comprises modifying the connection information of at least one of the objects.

6. A method as recited in claim 1, wherein said steps (c) and (e) each comprise selectively loading files of objects into the corresponding runtime environment.

7. A method as recited in claim 6, wherein said step (b) comprises storing the objects as Java classes and wherein said steps (c) and (e) each comprise executing a custom class loader for selectively loading Java classes of the corresponding version into a Java virtual machine running on the integration server.

8. A method as recited in claim 1, wherein said step (a) comprises using an object oriented modeling environment to define business processes and connections therebetween to create an integration model.

9. A method as recited in claim 1, further comprising:
(f) executing the first version of the project and the second version of the project concurrently on the integration server.

10. A method as recited in claim 1, wherein the first version of the project is dependent on a first version of another project and the second version of the project is dependent on a second version of another project, and wherein said step (c) comprises loading the first version of another project in the first runtime environment and said step (e) comprises loading the second version of another project in the second runtime environment.

11. A method as recited in claim 1, further comprising:
(g) designating a version of the project to be undeployed; and
(h) removing all information relating to the designated version from the repository.

12. A method of deploying plural versions of an object oriented, graphical model of a computer architecture for integrating business processes, said method comprising:
(a) defining a plurality of components, at least one of said components including executable process logic of a business process and at least one port defining a standard representation of an external interface of said component;
(b) defining connections between ports of desired components;
(c) storing said components and connections in a repository as a set objects;
(d) loading the set of the objects as a first version of a project in a first runtime environment of an integration server by configuring run time properties of the set of the objects;
(e) modifying the set of the objects; and
(f) loading the set of the objects, as modified, as a second version of the project in a second runtime environment of the same integration server by configuring run time properties of the set of the objects.

13. A method as recited in claim 12, wherein said steps (d) and (f) each comprise designating at least one node in which software is to be executed, said at least one node being on the same integration server.

14. A method as recited in claim 12 wherein said step (e) comprises modifying one of the objects in the set of the objects.

15. A method as recited in claim 12, wherein said step (e) comprises adding an object to the set of the objects.

16. A method as recited in claim 12, wherein said step (e) comprises modifying the executable process logic of one of the objects.

17. A method as recited in claim 12, wherein said step (e) comprises modifying of least one of the connections.

18. A method as recited in claim 19, wherein said steps (d) and (f) each comprise selectively loading files of objects into the corresponding runtime environment.

19. A method as recited in claim 18, wherein said step (c) comprises storing the objects as Java classes and wherein said steps (d) and (f) each comprise executing a custom class loader for selectively loading Java classes of the corresponding version into a Java virtual machine running on the integration server.

20. A method as recited in claim 12, further comprising:
(g) executing the first version of the project and the second version of the project concurrently on the integration server.

21. A method as recited in claim 12, wherein the first version of the project is dependent on a first version of another project and the second version of the project is dependent on a second version of another project, and wherein said step (d) comprises loading the first version of another project in the first runtime environment and said step (f) comprises loading the second version of another project in the second runtime environment.

22. A method as recited in claim 12 further comprising:
(h) designating a version of the project to be undeployed; and
(i) removing all information relating to the designated version from the repository.
